(19) United States
(12) Patent Application Publication
(10) Pub. No.: US 2015/0220647 A1
(43) Pub. Date: Aug. 6, 2015

(54) Interactive GUI for clustered search results

(71) Applicant: Santosh Kumar Gangwani, Nizamabad (IN)

(72) Inventor: Santosh Kumar Gangwani, Nizamabad (IN)

(21) Appl. No.: 14/554,084

(22) Filed: Nov. 26, 2014

Related U.S. Application Data
(60) Provisional application No. 61/934,704, filed on Feb. 1, 2014.

(51) Int. Cl. G06F 17/30

(52) U.S. Cl. CPC G06F 17/30867; G06F 17/3053

(57) ABSTRACT

Typical search engines include document snippets. There is no progression from a big picture view of search results to more detailed views. This invention creates a big picture view of search results in terms of cluster/category/topic/facet summaries/snippets. Cluster summary/snippet also has a few top ranking document snippets unlike other clustering search engines. Interactivity is provided for the user to see more/less results of each cluster/category/topic/facet. This helps in better understanding and navigation of search results. Can use traditional windows/rectangles for clusters/categories and sub-rectangles for documents. Alternatively can use a modified treemap. Each cluster with title becomes a parent in the treemap. Unlike traditional treemaps which show all children at a level, it shows a subset of children. A further alternative uses circles/balloons to represent clusters. Documents are shown as sub-circles. Clustering is also improved by additionally using ‘similar terms’ for clustering and getting cluster titles.

### BACKGROUND OF THE INVENTION

Typical search engines show search results in terms of document snippets. Browsing and finding right results takes significantly more time than the machine time required for searching results. One has to go through each document snippet and see if it is relevant. No summary/snippet of entire search is provided. No easy way to understand/digest/comprehend entire search results. Navigating to relevant results is difficult. Sometimes a relevant result is found after seeing several pages of documents. There is no progression from a big picture view of search results to more detailed views. No easy way to reject one entire category of results. No easy way to show interest in one category of results and see more and more results of that category. No easy way to filter results by further giving keywords. Basically current search visualization systems are document oriented and don't address entire search. They don't show a big picture view followed by more details where required.

U.S. Pat. No. 8,549,436 (Capriati) uses thumbnails for documents. But shows only one document at a time making it more difficult to get to relevant documents and understanding the entire document set.

U.S. Pat. No. 7,735,018 (Bakhash) proposes 3D GUI. It is document level only. It does not help to get to relevant documents easily or to understand/comprehend/digest search results easily.

Some of current methods cluster the result search documents or find facets in the result search documents. They show by default search result documents' snippets as other search engines do. They also show cluster/facet titles as options. The user can select a cluster and see documents in the cluster. The user can see documents of a single cluster only at a time. U.S. Pat. No. 7,502,786 (Shixia Liu), U.S. Pat. No. 8,370,331 (Pontier), U.S. Pat. No. 7,912,823 (Ferrari), U.S. Pat. No. 8,335,784 (Gutt), U.S. Pat. No. 7,644,373 (Jing) and U.S. Pat. No. 7,720,292 (Lynne Marie Evans) all relate to showing search results in terms of clusters or facets. “Resultmaps: Visualization for search interfaces” (Edward Clarkson, Krishna Desai, James Foley) shows search result document snippets and a separate treemap for clusters. They all show cluster information and document snippets separately.

One of the problems with these approaches is that comprehension/digestion of search results information is difficult. This is because there is no attempt to show summary/snippet of the entire search. There is no progression from a big picture view of search results to more detailed views. In other words there is no bird's eye view of search results followed by more detailed views. This makes comprehension/digestion of search results difficult.

Another problem is that selecting and navigating to desired results is still difficult. A user may find a relevant document after several pages of browsing. This is because the GUIs are still document oriented with separate options of showing clusters/facets. While for documents they not only show title, but also URL and a snippet, for clusters they show only titles by default. They don't treat clusters/facets as first class citizens like they do for documents. The default screen still shows the top ten documents like the earlier search engines which is disjoint from the clusters and logically does not fit well with the clusters which are based on automatic meta-data like titles. They do not show any documents of any cluster/facet by default. The user has to click on cluster/facet title to see any of it's documents. The user can never see more than one cluster/facet documents at all. There are multiple separate views of documents, they are disjoint. There is interaction in terms of filtering and seeing only one cluster/facet by clicking on the cluster title. But they have only title of cluster/facet to guide them and no snippet of the cluster/facet.

U.S. Pat. No. 8,280,901 (McDonald) tries to solve the problem of showing the results of a second search along with one search. It does not address at all the problems of difficult selection/comprehension/navigation. What is desired, is to solve the problem of selecting, navigating and comprehension of search result along with enabling further searches on the search results. A more holistic approach is required.

All of these use position of document to convey rank, higher ranking documents are placed before lower ranking ones. They don't use colors and area to make identifying and navigating to relevant results more effective.

Accordingly, what is desired, and not heretofore been developed, is a search results visualization where results are organized in terms of summarized information first so that the user can understand/digest all search results. The user should get the big picture view or a bird's eye view of the search results.

What is also desired is that there be a holistic progression from big picture view to details which should make navigation to relevant results more easier in terms going through less irrelevant results. There needs to be sufficient information of the categories/topics/clusters/facets for the user to choose a category/cluster/topic/facet. The big picture/snippet/summary of search results should help the user see the different categories/varieties/facets of results. The user should be able to see and choose directly high priority documents of each category without a single click. The category/cluster/topic/facet should be treated like a first class citizen. Category/cluster/topic/facet snippet/summary needs to be shown with a few high priority document snippets without a single click. The user should be able to choose to go to more documents of any category/variety/facet/topic/cluster the user finds interesting.

What is also desired is to have at least two levels of getting more and more results in the area/part of search results the user is interested in. One level is seeing more results of the selected part in current search results. Another level is to make additional search with the selected part and get further search results related to the selected part from the document sources.

What is further desired is to make it easy for users to select and navigate to relevant results by not just using position but also color and area allotted.

### SUMMARY OF THE INVENTION

Browsing and finding right results takes significantly more time than the machine time required for searching results. Understanding the search results, selecting and navigating to the relevant results is difficult. One object of the invention is the concept of summary of entire search in terms of cluster/topic/category/facet snippets/summaries. This search summary makes understanding/digesting search results easier and also selecting relevant documents faster. Typical search engines show summary/snippet of individual search result documents. In addition to summary/snippet of individual documents, this invention creates and displays a summary of all the result documents, that is, a summary of the search performed. Search results are organized in terms of summarized information first and the user can get more information in the area/part of results he/she is more interested in. Summary of the entire search is created in terms of summary/snippet of each of the clusters/topics/categories/facets found dynamically in the search results. Just like a document snippet in the search results makes a document understandable without going through entire document, similarly a cluster/topic/category/facet snippet makes a cluster/category/facet understandable without going through all documents. Note that a document snippet is not just it's location/url but also it's title and a brief snippet. Similarly a cluster/topic/facet/category summary/snippet includes not just title and number of documents, but also a few high ranking documents. This is unlike other cluster based search GUIs which only show titles of clusters. This gives an effective big picture view of search results to the user unlike other search GUIs. Clusters/topics/categories/facets are treated as first class citizens similar to documents unlike other search cluster GUIs which have a document GUI and clusters/topics/categories/facets as options. The inclusion of high ranking documents in cluster snippet also makes selection of relevant results faster. The user can directly look at high ranking documents of each cluster with a zero click mechanism. This is unlike other search cluster GUIs which show clusters/categories/facets as options to be explored by further actions. The number of document snippets included in cluster/topic/category/facet summary/snippet could be constant or variable. The number of documents included in cluster/category/facet snippet can vary based on cluster ranking and size of display view. Total number of documents and number of documents in each cluster/facet/category are also shown. This search summary makes understanding/digesting and selecting search results easier.

Layout of search summary showing cluster/topic/facet/category snippets and document snippets can be done dynamically. Based on display size, cluster/topic/facet/category snippets are allocated space on the screen. On larger screens, cluster/topic/facet/category snippets get more area and show more documents in first screen. Correspondingly smaller screens mean less documents per cluster snippet. This makes it suitable for not just on desktops but on multiple devices like tablets/mobiles/glass devices/etc. Typically the layout engine shows at least a few clusters/facets in the first page and the user can flip/scroll to more clusters/topics/facets/categories. A gap space is also left between clusters to make them easily distinguishable.

A further object of the invention aids the user to identify and navigate to relevant information in search results using not just position but also colors and area allotted to results/clusters/topics/categories/facets. The invention uses different colors for different clusters/topics/categories/facets so as to make them easily distinguishable. Colors are used to indicate type of data: clusters/titles/documents/urls/etc. Size of the document/cluster and it's position both indicate ranking. Higher ranking clusters are allocated more area and hence show more documents. Also, higher ranking clusters are shown first and then low ranking ones. So, the user sees higher ranking clusters/facets first and also the snippet of higher ranking clusters/topics/categories/facets is larger. Even the documents shown in the snippet are ordered by rank, higher ranking documents shown first. Basically documents and clusters are sorted by rank, so top ranking documents and clusters would be shown first allowing for getting to relevant documents faster.

Ads are handled specially. Configuration parameters define how to handle ads. They are shown in the top 3 positions or bottom position of the clusters In another implementation, for first cluster the ads are shown at the bottom, for other clusters they are shown in the first three positions. Configuration parameters can dictate for each cluster how to show ads. There can also be a separate ads cluster.

Another object of the invention is to have user interaction to get more/less results of each cluster/topic/category/facet. This aids in navigating to relevant documents faster. Interactive options are provided in terms of seeing more results of any topic on a click, less results of a topic or filtering out a topic altogether, seeing more topics, searching again with keywords of a topic, etc. The invention provides multiple zoom points one for each cluster/facet which can help the user zoom in/out of each cluster/topic/category/facet separately. Basically, for each cluster/topic/category/facet we give the user an option to see more/less results. This makes navigating to relevant results easier. The GUI works recursively to show summary of sub-clusters and giving option of getting more details in case of sub-clusters.

The invention takes care of allowing multiple devices to browse results. Can use touch devices flip/swipe/mouse scroll/keyboard keys to see more clusters. Can use tap/click on topic to see more results of topic. Can use tap/click on document to go to the document.

A further object of the invention provides multiple levels of zoom in/out. One level is seeing more results of the selected cluster/topic/category/facet in current search results. Another level makes an additional search with the selected cluster/topic/category/facet title automatically and gets further search results related to the selected cluster/facet from the document sources. Levels also correspond to any hierarchy in clusters, so any sub-clusters at level 1 will show up more results in level 2. In this way, the invention also addresses further searches in addition to providing easy comprehension and navigation of search results.

The user can also filter search results by keywords. A new cluster is created with the search input as title and second search results as cluster documents.

Hierarchical clusters are serialized in summary mode and shown as proper cluster snippets with parent, children and interaction in zoom modes allowing further zoom modes.

The invention further provides three concrete/specific realizations/objects commensurate with the above listed search GUI objects.

One realization of the GUI uses traditional windows the users are familiar with already. Each cluster/topic/category/facet is shown in one window. There is a rectangular region allotted to the cluster title in the window. The documents in the cluster are allotted rectangular regions. As discussed earlier, the invention basically shows whatever high score documents/clusters fit into display space. Use of cluster/document area and color is done as discussed earlier. This realization add interactivity in terms of seeing more/less results of any cluster by using the familiar minimize/maximize/close buttons on each cluster window.

A second realization of this approach uses a modified treemap for showing cluster/topic/category/facet summaries/snippets. Clusters become first level of parents, they show cluster title. Documents of the cluster are children of the cluster node. They show document summary/snippet. Typical treemaps including “Resultmaps: Visualization for search interfaces” (Edward Clarkson, Krishna Desai, James Foley) show all nodes at each level displayed. Unlike traditional treemaps which show all children at each level, only a subset of the documents are shown at documents level. The number of documents shown varies based on rank of the cluster and display view size. The cluster is allotted a percentage of the area of the display screen based on cluster priority. As discussed in earlier section, the algorithm basically shows whatever high score documents/clusters fit into display space allotted to the cluster. Use of cluster/document area and color is done as discussed earlier. Interactivity is provided in terms of zoom in/out buttons.

For both of the above realizations, the summary screen uses ‘slice-dice’ layout if number of clusters is less than a configurable value, else uses ‘squarify’ layout. Same is the case with zoom-in view. Since zoom mode typically has more elements, it ends up using ‘squarify’ layout more often. Note this invention does not limit to this layout and can work with other layouts. One algorithm is given here to show feasibility of the system. For example, could have horizontal layout with each cluster/topic/category/facet taking one full horizontal row. Could have vertical layout with each cluster/topic/category/facet taking one full vertical row.

A third realization of this approach is to use circles/balloons to represent clusters/topics/categories/facets. The invention displays the clusters as circles. The documents are shown as sub-circles. The search summary is shown in terms of cluster/topic snippets to give a peek into entire search results. The user can click/tap on any topic/cluster to see more documents in any cluster. Use of cluster/document area and color is done as discussed earlier.

Cluster/facet titles are most important in giving an idea about the cluster. This invention improves the quality of clusters and cluster titles generated. In addition to frequency of keyword itemsets, this patent additionally uses ‘similar search’ keywords to choose the best words to show in the cluster/facet title. The words in ‘similar search’ keywords are given highest priority in choosing cluster/facet titles. Clusters/facets with words from ‘similar search’ keywords are also given higher ranking/score/weight.

### BRIEF DESCRIPTION OF THE DRAWINGS

FIG. 1 is a view of the processes involved in a typical cluster based search engine.

FIG. 2 is a view of processes involved in creating clusters.

FIG. 3 is a view of processes involved in creating snippets of clusters.

FIG. 4 is a view of processes involved in creating interactive GUI for search result clusters using cluster snippets

FIG. 5 is a view of processes involved in creating a multiple windows based interactive GUI for search result clusters

FIG. 6 is a view of the multiple windows based interactive GUI for search result clusters using cluster snippets

FIG. 7 is a zoom mode view of the multiple windows based interactive GUI showing a zoomed cluster

FIG. 8 is a view of processes involved in creating a modified treemap based interactive GUI for search result clusters

FIG. 9 is a view of the modified treemap based interactive GUI for search result clusters using cluster snippets

FIG. 10 is a zoom mode view of the modified treemap based interactive GUI showing a zoomed cluster

FIG. 11 is a view of processes involved in creating a circles based interactive GUI for search result clusters

FIG. 12 is a view of the circles based interactive GUI for search result clusters using cluster snippets

FIG. 13 is a zoom mode view of the circles based interactive GUI showing a zoomed cluster

### DETAILED DESCRIPTION OF THE INVENTION

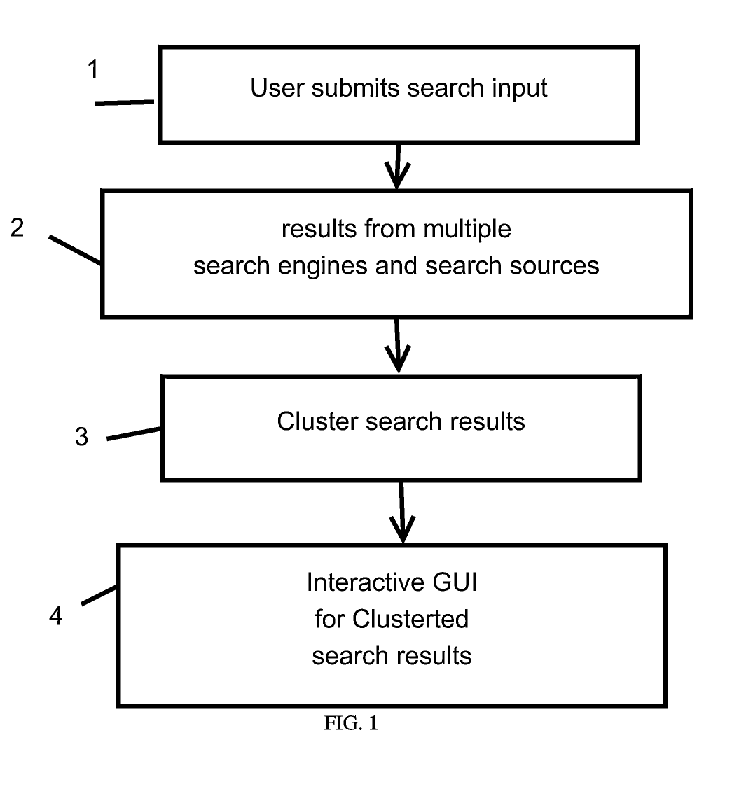

FIG. 1 is a view of the processes involved in a typical cluster/topic/category/facet based search engine. “A survey of web clustering engines” (Claudio Carpineto, Stanislaw Osinski, Giovanni Romano and Dawid Weiss) gives a good survey of existing clustering based search engines. There are also several classification/categorization techniques which basically use fixed number of classes. Typical search engines which create clusters/topics/categories/facets out of search results have four components. The first component of search engine takes input from user, search input 1. The second component performs a search using the input keywords, search results 2. The third component takes search results and performs clustering/categorization/facet creation over the search results to give clustered search results, search clusterresults 3. The fourth component takes clusters/topics/categories/facets of search results and creates an interactive visualization, search guiforclusters 4. This invention provides systems which visualize clusters/topics/categories/facets of search results in novel ways. So, this invention mainly corresponds to the fourth component, search guiforclusters 4. One claim of this invention also corresponds to the third component. This document describes all the four components to give the picture of the complete system and it's feasibility. This invention can work with any implementation of the first three components.

The first component in the search workflow, FIG. 1, takes input from the user. It could be keywords, sentences, a custom search GUI with options to select, etc. It could have auto-complete. It is independent of communication mechanism used to get the search input to search system, it could be socket/http, synchronous/asynchronous, etc. but not limited to these. This invention is independent of how the input is got from the user and how it reaches the search system. No claim is made for invention in this step.

The second component in the search workflow, FIG. 1, takes input keywords and performs search. The search could search multiple sources and also could call other search APIs, to get search results. The sources could be like the users' personal devices desktop/mobile/tablet/glasses/watch/camera/sensors, could be Internet, databases, services, organization data, etc though not limited to these. The searches could use caches, indexes, one or more machines to get the results, etc. This invention is for any search sources and/or APIs and is independent of how and where the search results are got from. Note the search results can include ads from ad server APIs too. No claim is made for invention in this step.

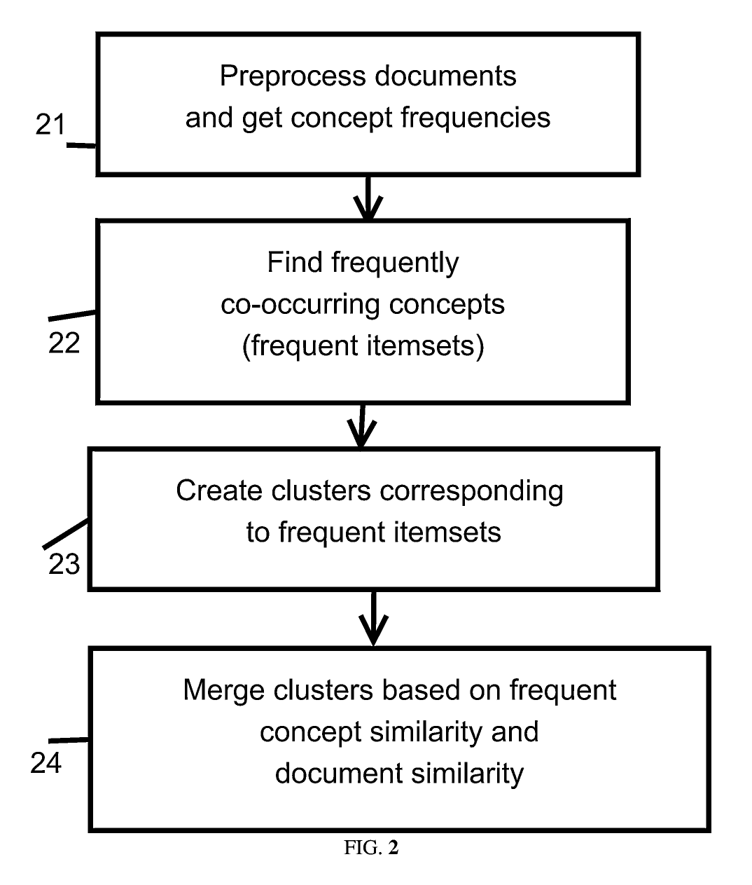

The third component in the search workflow, FIG. 1, takes search results and creates clusters/topics/categories/facets from the search results to give clustered search results, search clusterresults 3. Please note there are a lot of existing algorithms to do this. “An analysis of web document clustering algorithms 1” (K Sridevi, R Umarani) gives a review of some of the methods. G V R Kiran, Ravi Shankar, V. P. (2010) Frequent itemset based hierarchical document clustering using wikipedia as external knowledge In KES' 10 Proceedings of the 14th International conference on Knowledge-based and Intelligent information and engineering systems: Part II pages 11-20. Springer-Verlag Berlin, Heidelberg gives another recent clustering method for clustering. FIG. 2 is a view of processes involved in creating clusters from search results similar to algorithm given in G V R Kiran, Ravi Shankar, V. P. (2010) Frequent itemset based hierarchical document clustering using wikipedia as external knowledge In KES' 10 Proceedings of the 14th International conference on Knowledge-based and Intelligent information and engineering systems: Part II pages 11-20. Springer-Verlag Berlin, Heidelberg This invention works with hierarchical clusters/topics/categories/facets and non-hierarchical as well. The techniques for creating clusters/topics/categories/facets may use additional meta-data one example of which is wikipedia being used in G V R Kiran, Ravi Shankar, V. P. (2010) Frequent itemset based hierarchical document clustering using wikipedia as external knowledge In KES' 10 Proceedings of the 14th International conference on Knowledge-based and Intelligent information and engineering systems: Part II pages 11-20. Springer-Verlag Berlin, Heidelberg. The documents could be multiple formats like text/audio/video/images/etc along with meta-data. There are techniques for creating clusters/topics/categories/facets corresponding to all formats which can be used.

There is one claim in the clustering search results step. This invention improves the quality of clusters and cluster titles generated. This invention uses additional information provided by ‘similar search’ keywords to choose the best clusters. Clusters with words from ‘similar search’ keywords are given higher weight while creating clusters. ‘Similar search’ keywords are also used to get the best cluster title. The words in ‘similar search’ keywords are given highest priority in choosing cluster titles. The rest of the invention is independent of how clustering is done for the search results and works with any clustering method.

The fourth component in the search workflow, FIG. 1 takes search result clusters/topics/categories/facets and provides an interactive visualization. This invention provides systems which visualize clusters/topics/categories/facets of search results in novel ways.

This invention introduces a concept called cluster/topic/category/facet snippet. Typical search engines display individual document snippets as part of search results. Just like a document snippet in the search results makes a document understandable without going through an entire document, similarly a cluster/topic/category/facet snippet makes a cluster/topic/category/facet understandable without going through all documents in the cluster. Note that a document snippet is not just it's location/url but also it's title and a brief relevant snippet, screenshots/images are included where relevant. Similarly a cluster/topic/category/facet summary/snippet includes not just title, rank and number of documents, but also a few high ranking document snippets.

This invention introduces another concept called search summary or a big picture view of the search results. Browsing and finding right results takes significantly more time than the machine time required for searching results. Understanding the search results, selecting and navigating to the relevant results is difficult. Search results can be organized in terms of summarized information or the big picture of search results first. An effective search summary makes understanding/digesting search results easier and also selecting relevant documents is faster. This summary has to be readable for the user to be able to understand/digest the results. The summary also needs to have interactive points to get details where required. An effective search visualization system makes going from search results summary to required details easier and intuitive.

This invention provides a system for interactive visualization system of search results. This system creates the summary or big picture view of the search results. The summary of search results is created by combining all cluster/topic/category/facet snippets/summaries. It also allows users to see more search results in any part of the summary screen providing detailed views. It allows for seamless navigation from big picture view to detailed views.

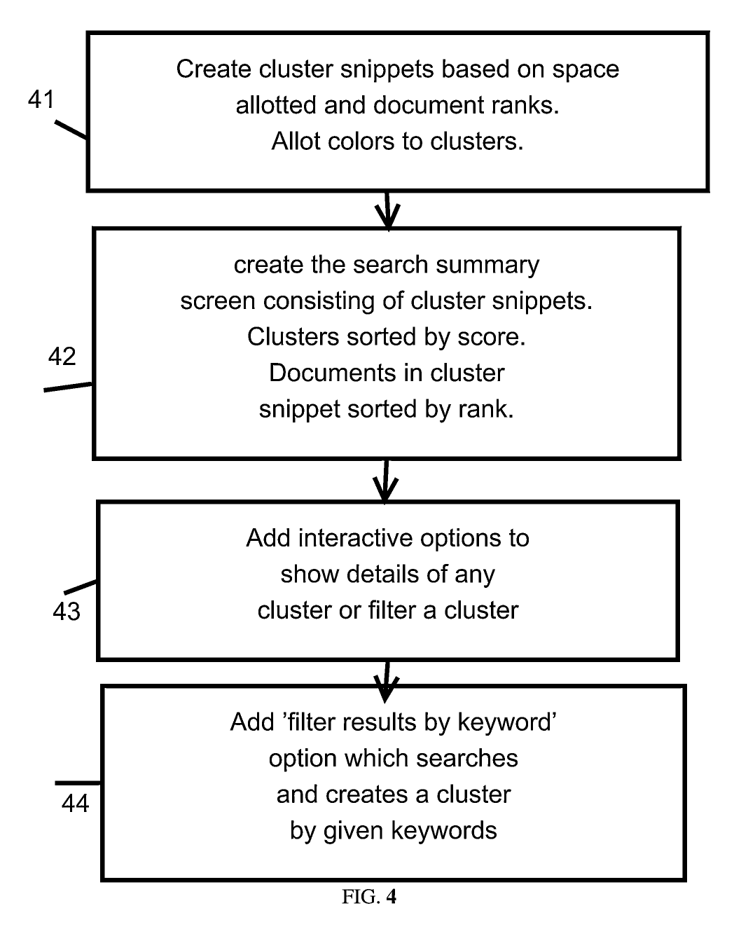

FIG. 4 is a view of the processes involved in creating the interactive GUI. In the first step, gui snippets 41, search cluster/topic/category/facet snippets are created. In the second step, gui summary 42, a summary or big picture view is created consisting of search cluster/topic/category/facet snippets. In the third step, interaction options are added the GUI, gui interaction 43. Options like seeing more results of any cluster/topic/category/facet or removing a cluster/topic/category/facet from the view, seeing more clusters/topics/categories/facets, etc. are added. In the fourth step, filter options like reducing results by keyword search within results are added to the GUI, gui filter 44. Below each of these 4 steps are discussed in more detail.

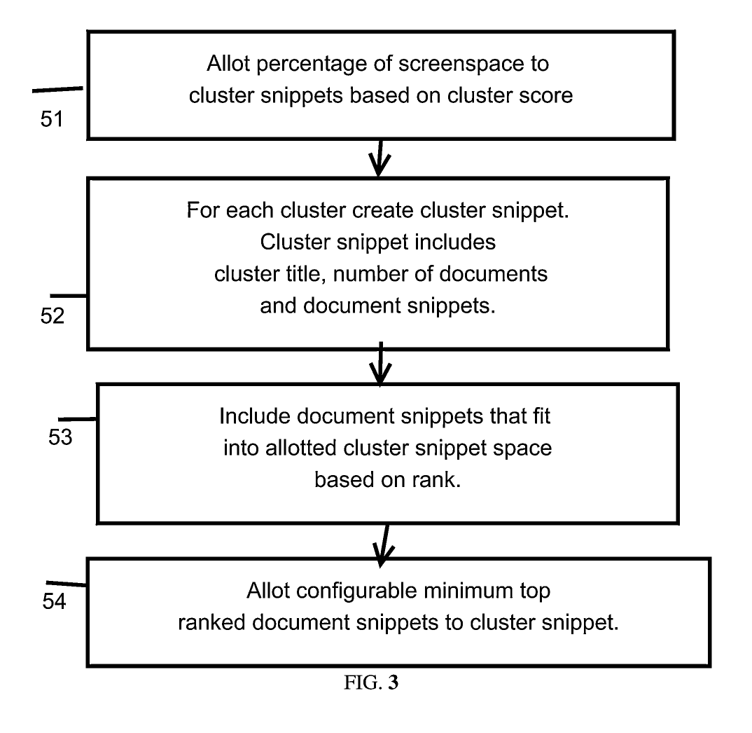

One part of this invention is a system which takes search results' clusters/topics/categories/facets and creates cluster/topic/category/facet snippets. In the interactive search GUI, FIG. 4, this corresponds to the first step, gui snippets 41. FIG. 3 is one view of the processes involved in creating snippets of clusters/topics/categories/facets. First step, snippet space 51, involves allotting each cluster/topic/category/facet a portion of the display screen. The number of document snippets in cluster/topic/category/facet summary could be a constant or a variable. In constant case, the cluster/topic/category/facet summaries are allotted same amount of screen space. For variable space the following is done. Display screen height and width are calculated based on display size, space required for other page items like search box, copyright notice, space between clusters, etc. The system gets the sum of scores of all the clusters. Each cluster score is divided by sum of all scores to get the cluster score proportion. Note sum of cluster score proportions would be one. The cluster is allotted the proportion of screen based on the cluster score proportion. For example, if there are 3 clusters, one with score 4 and the others with score 2. If display area after removing space for other items is 10000. Then cluster 1 gets area of 5000, cluster 2 and 3 each get area of 2500.

In the second step, snippet docs 53, involves allotting document snippets to each cluster snippet based on area allotted in step 1. For constant number of snippets, this step is not required. The cluster title size is removed from cluster snippet size. The cluster title size is configurable. The system gets the space required for each document snippet based on display size. The system divides display sizes into at least 3 sizes, large, medium and small. The number and display sizes are configurable. For each display size, there is a configurable document snippet size. For smaller displays, the document snippet size is small, so not entire description maybe visible without zooming in. Based on document snippet size and the cluster snippet size, the system gets how many document snippets fit in each cluster snippet.
Some of the cluster snippets may not get any document snippets at all. This can be avoided by a configurable entry for minimum number of documents in a cluster snippet, snippet mindocs 54. The display has to take care of larger area than display size.

A second object of the invention is a system which creates summary of entire search in terms of cluster snippets described already. In the interactive search GUI, FIG. 4, this corresponds to the second step, gui summary 42. Typical search engines show summary/snippet of individual search result documents. In addition to summary/snippet of individual documents, this invention creates and displays a summary of all the result documents, that is, a summary of the search performed. Summary of the entire search is created in terms of summary/snippet of each of the clusters/facets found dynamically in the search results. Note that a document snippet in not just it's location/url but also it's title and a brief snippet. Similarly a cluster/facet summary/snippet includes not just title and number of documents, but also a few high ranking documents unlike other cluster based search GUIs. This gives an effective big picture view of search results to the user unlike other search GUIs. Clusters/facets are treated as first class citizens similar to documents unlike other search cluster GUIs which have a document GUI and clusters as options. The inclusion of high ranking documents in cluster snippet makes selection of relevant results faster. The user can directly look at high ranking documents of each cluster with a zero click mechanism unlike other search cluster GUIs which show clusters as options to be explored by further actions. The number of document snippets included in cluster/topic/category/facet summary/snippet could be constant or variable. The number of documents included in cluster snippet can vary based on cluster ranking and size of display view. Total number of documents and number of documents in each cluster are also shown. This search summary makes understanding/digesting search results easier and also selecting relevant documents is faster.

Another object of the invention creates the layout of the summary showing cluster snippets dynamically based on display size. Based on display size, cluster/facet snippets are allocated space on the screen. On larger screens, cluster snippets get more area and show more documents in first screen. Correspondingly smaller screens mean less documents per cluster snippet. This makes it suitable for not just desktops but also multiple devices like tablets/mobiles/glass devices/etc. Typically the layout engine shows at least a few clusters/facets in the first page and the user can flip/swipe/scroll or use arrow keys or use mouse wheel to see more clusters/facets.

A further object of the invention aids the user to identify and navigate to relevant information in search results using not just position but also colors and area allotted to results/clusters/topics/categories/facets. The invention uses different colors for different clusters/topics/categories/facets so as to make them easily distinguishable. Colors are used to indicate type of data: clusters/titles/documents/urls/etc. Size of the document/cluster and it's position both indicate ranking. Higher ranking clusters are allocated more area and hence show more documents. Also, higher ranking clusters are shown first and then low ranking ones. So, the user sees higher ranking clusters/topics/categories/facets first and also the snippet of higher ranking clusters/facets could be larger. Even the documents shown in the snippet are ordered by rank, higher ranking documents shown first. Basically documents and clusters are sorted by rank, so top ranking documents and clusters would be shown first allowing for getting to relevant documents faster.

Ads are handled specially. Configuration parameters define how to handle ads. They can be shown as a separate cluster/topic/category/facet. They can be shown in the top 3 positions or bottom position of the clusters/topics/categories/facets. In another implementation, for first cluster/topic/category/facet the ads are shown at the bottom, for other clusters they are shown in the first three positions. Configuration parameters can dictate how to show ads.

Another object of invention is the interaction options provided to the user to get more information in the part the user is interested. In the interactive search GUI, FIG. 4, this corresponds to the third step, gui interaction 43. The interactive visualization system of this invention organizes search results in terms of summarized information first and allows the user to get more information in the area/part of results he/she is more interested in. Interaction options are provided for each cluster/topic/category/facet. For each cluster/topic/category/facet, an option is provided for seeing more results. An option is provided to see less results and also to remove the cluster/topic/category/facet snippet completely. The user can flip/scroll/swipe or use mouse wheel or use arrow keys to see more clusters/topics/categories/facets if any. This makes navigating to relevant results easier. The GUI works recursively to show summary of sub-clusters and giving option of getting more details in case of sub-clusters.

The invention takes care of allowing multiple devices to browse results. Can use touch devices flip/swipe/mouse scroll to see more clusters/topics/categories/facets. Can use tap/click on topic title to see more results of topic. Can use tap/click on document url to go to the document.

A further object of the invention provides multiple levels of zoom in/out. One level is seeing more results of the selected cluster/topic/category/facet in current search results. Another level makes an additional search with the selected cluster/topic/category/facet title automatically and gets further search results related to the selected cluster/topic/category/facet from the document sources. In this way, the invention also addresses further searches in addition to providing easy comprehension and navigation of search results.

Hierarchical clusters/topics/categories/facets are serialized in summary mode and shown as proper cluster/topic/category/facet snippets with parent, children and interaction in zoom modes allowing further zoom modes.

The user can also search by keywords and a new cluster/topic/category/facet is created with the search input as title and search results as cluster documents. In the interactive search GUI, FIG. 4, this corresponds to the fourth step, gui filter 44. This new cluster/topic/category/facet is given highest score in the search results.

The user can also save the results locally or on a remote server and also share it with others through social APIs.

The invention further provides three concrete/specific realizations commensurate with the above described interactive search GUI and the search GUI objects.

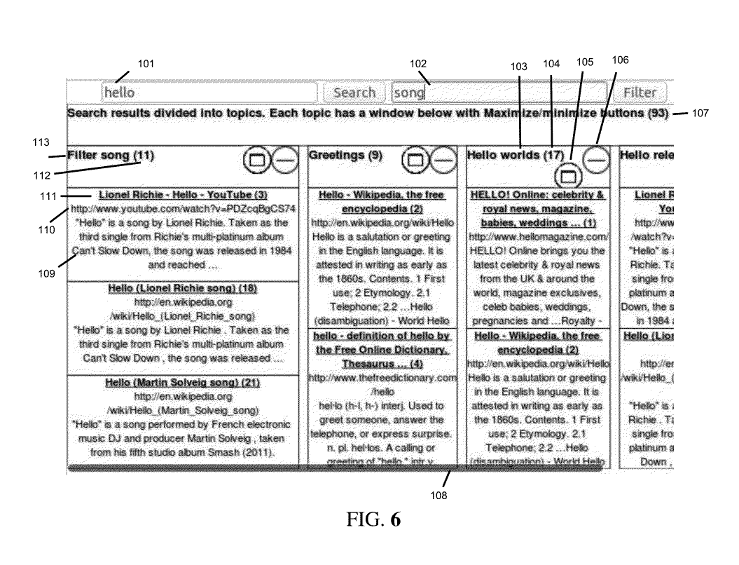

One concrete/specific visualization for the interactive visualization system of this invention uses traditional windows that users are already familiar with. FIG. 6 is a view of the multiple windows based interactive GUI for search result clusters using cluster/topic/category/facet snippets. This shows layout of the GUI. It has a search box, windowsgui searchbox 101. A filter by keywords box which allows users to search within existing search results, windowsgui filterbox 102. For each cluster/topic/category/facet, the system allots a window/rectangle, windowsgui cluster 103. There is a rectangle allotted to display cluster details as seen in windowsgui cluster 103. Cluster title is shown in the rectangle allotted to the parent. Number of documents in the cluster/topic/category/facet is also shown, windowsgui clusternumdocs 104. The system allots sub-rectangles for each document snippet, windowsgui docsnippet 109. A document snippet can consist of title/name, windowsgui doctitle 111. It can consist of a location, windowsgui docurl 110. It can consist of an optional document snippet, windowsgui docsnippet 109. It can also have a rank, windowsgui docrank 112. More items like type of the document, source of the document, thumbnail, document summary, etc. can also be shown for the document. As discussed earlier, the invention basically shows whatever high score documents/clusters fit into display space. A user can see more clusters/topics/categories/facets by scrolling/swiping or using mouse wheel or arrow keys, windowsgui scroll 108. Use of cluster/document area and color is done as discussed earlier. Windows are sorted by score and documents sorted by rank. This realization adds interactivity in terms of seeing more/less results of any cluster/topic/category/facet by using the familiar minimize/maximize/close buttons on each cluster window, windowsgui maximize 105 and windowsgui minimize 106.

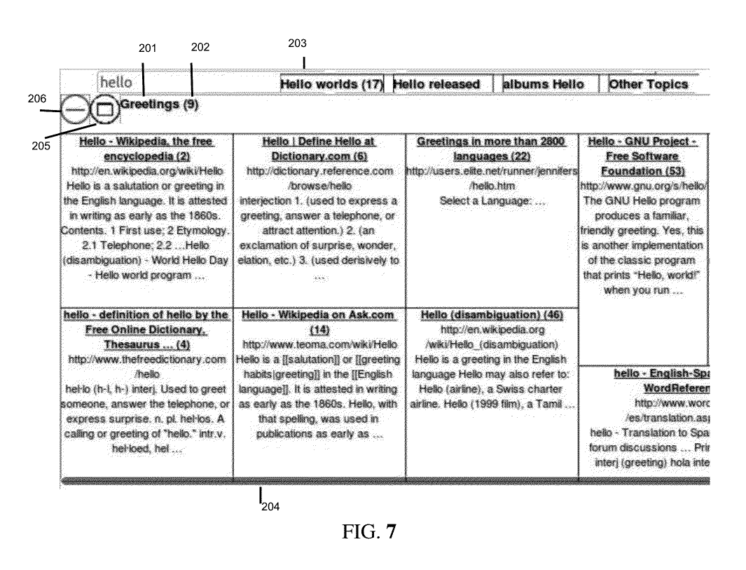

One zoom mode view of the windows based interactive GUI is given FIG. 7. It can show cluster/topic/category/facet details and document details as discussed in normal mode. The system allows the option of going directly to other clusters/topics/categories/facets, windowszoom otherclusters 203. It is similar to normal mode with all other aspects including search box, filter box, scroll, windowszoom scroll 204, interactive options like windowszoom maximize 205 and windowszoom minimize 206. The windowszoom maximize 205 also does an additional search with the cluster/topic/category/facet title words and gets more results which are shown along with the documents of the cluster/topic/category/facet. The windowszoom minimize 206 option takes the user back to the normal mode search summary.

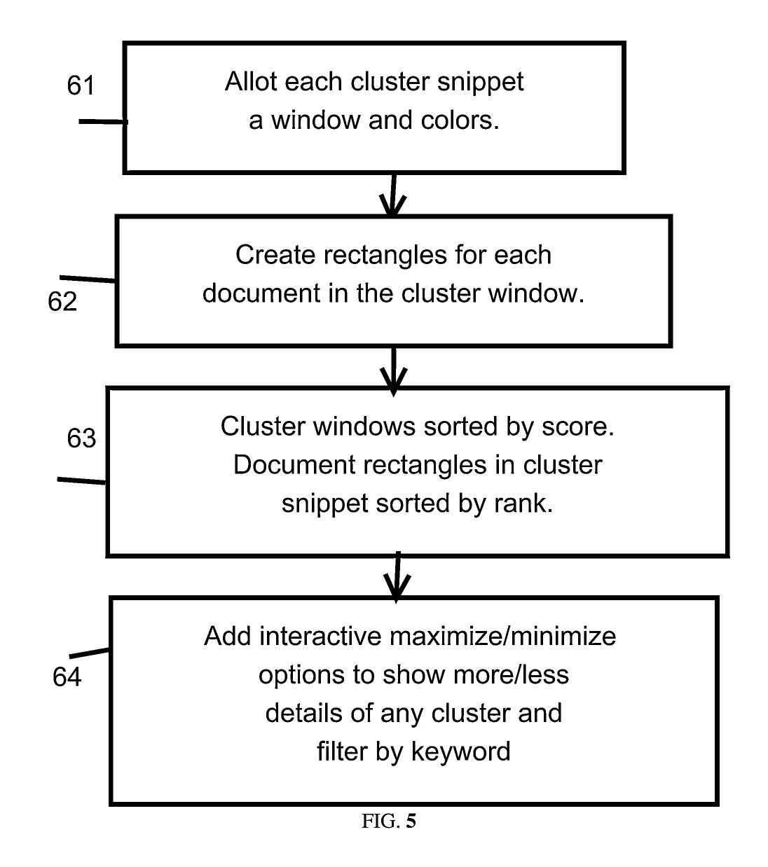

FIG. 5 is a view of the processes involved in creating the multiple windows based interactive GUI for search results. The first step involves allotting space to each cluster/topic/category/facet snippet. The number of document snippets in cluster/topic/category/facet summary could be a constant or a variable. In constant case, the cluster/topic/category/facet summaries are allotted same amount of screen space. For variable space the following is done. Based on cluster/topic/category/facet score, each cluster snippet is allocated a portion of the screen. Each cluster snippet is allocated a window. Based on screen space, a configurable area is fixed for each document snippet. Cluster/topic/category/facet snippet area is divided by each document snippet area to get number of document snippets to be shown for the cluster/topic/category/facet snippet. There is also a configurable minimum document snippets to be shown for each cluster/topic/category/facet snippet. This minimum document snippet is particularly useful to show clusters/topics/categories/facets that would otherwise be not shown at all because they have been allotted less space by the layout algorithm. A window is allotted to each cluster/topic/category/facet, window cluster 61. For each document snippet a rectangle is created, window document 62. Cluster/topic/category/facet windows are sorted by cluster score, higher score clusters are shown first. Cluster/topic/category/facet document rectangles are sorted by rank, higher rank documents are shown first. The options of horizontal scroll/swipe, etc are added. Colors are allotted to clusters/topics/categories/facets to make them easily distinguishable from one another. Options like fisheye are provided which increase the size and show all details when user hovers over the document or cluster. On maximize/minimize selection, window interact 64, the GUI is translated to the cluster start. The cluster/topic/category/facet document rectangles sizes if they can be increased based on screen size they are increased. Treemap layout is used to calculate exact coordinates for each cluster/topic/categofy/facet and document. The summary screen uses ‘slice-dice’ layout if number of clusters is less than a configurable value, else uses ‘squarify’ layout, for references to both these algorithms please see, Shneiderman, B., Wattenberg, and Martin (2001) Ordered treemap layouts In Proceedings of the IEEE Symposium on Information Visualization 2001 (INFOVIS'01)INFOVIS '01 pages 73—Washington, D.C., USA. IEEE Computer Society and Mark Bruls, K. H. and van Wijk, J. (1999) Squarified treemaps In Proceedings of the Joint Eurographics and IEEE TCVG Symposium on Visualization pages 33-42. Same is the case with zoom-in view. Since zoom mode typically has more elements, it ends up using ‘squarify’ layout more often. A few other example layouts, “Ordered and quantum treemaps: Making effective use of 2d space to display hierarchies” (Bederson, Benjamin B. and Shneiderman, Ben and Wattenberg, Martin), “Enhanced spatial stability with hilbert and moore treemaps” (S. Tak and A. Cockburn) and 3d Tanaka, Y., Okada, Y., and Niijima, K. (2004) Interactive interfaces of treecube for browsing 3d multimedia data In Proceedings of the Working Conference on Advanced Visual InterfacesAVI '04 pages 298-302 New York, N.Y., USA. ACM. Note this invention can work with other treemap layouts and is not limited to any single layout. One algorithm is given here to show feasibility of the system. For example, could have horizontal layout with each cluster/topic/category/facet taking one entire horizontal row. Could have vertical layout with each cluster/topic/category/facet taking one partial vertical row.

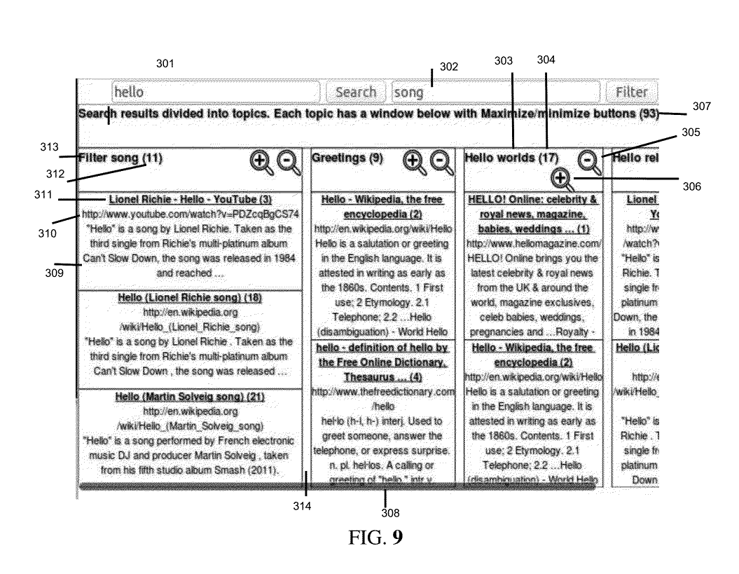

A second concrete/specific visualization for the interactive visualization system of this invention uses modified treemaps with summary screen showing only partial children unlike traditional treemaps which show all or no elements at each level. FIG. 9 shows a perspective view of the layout of the treemap GUI. It has a search box, treemapgui searchbox 301. A filter by keywords box which allows users to search within existing search results, treemapgui filterbox 302. It creates a treemap for the search results. Each cluster/topic/category/facet is allotted a parent element, treemapgui cluster 303. Cluster/topic/category/facet title is shown. Number of documents in the cluster/topic/category/facet is also shown, windowsgui clusternumdocs 104. Documents in a cluster/topic/category/facet are made children of the parent element in the treemap. Unlike traditional treemaps which show all children at a level, the number of documents varies based on rank and display view size. Typical treemaps including “Resultmaps: Visualization for search interfaces” (Edward Clarkson, Krishna Desai, James Foley) show all nodes at each level displayed. This invention shows only a few of the nodes at each level in order to have a summarized display. An additional modification introduces space gaps between clusters/topics/categories/facets to make them better distinguishable as shown in treemapgui gapspace 314. Cluster/topic/category/facet nodes are the first level of parents, they show title. Documents of the cluster are children of the cluster node. They show document summary. The cluster/topic/category/facet is allotted a percentage of the area of the display screen based on it's priority. As discussed in earlier section, the algorithm basically shows whatever high score documents/clusters fit into display space allotted to the cluster. A document snippet can consist of title/name, treemapgui doctitle 311, a location, treemapgui docurl 310, an optional snippet, treemapgui docsnippet 309, a rank, treemapgui docrank 312. More items like type of the document, source of the document, thumbnail, document summary, etc. can also be shown for the document. As discussed earlier, the invention basically shows whatever high score documents/clusters fit into display space. A user can see more clusters/topics/categories/facets by scrolling/swiping/mousewheel/arrow keys, treemapgui scroll 308. Use of cluster/document area and color is done as discussed earlier. Parents are sorted by score and documents sorted by rank. It provides interactivity in terms of zoom in/out options, treemapgui maximize 305 and treemapgui minimize 306.

One way of creating layout is provided below. The summary screen uses ‘slice-dice’ layout if number of clusters/topicscategories/facets is less than a configurable value, else uses ‘squarify’ layout, for references to both these algorithms please see, Shneiderman, B., Wattenberg, and Martin (2001) Ordered treemap layouts In Proceedings of the IEEE Symposium on Information Visualization 2001 (INFOVIS'01)INFOVIS '01 pages 73—Washington, D.C., USA. IEEE Computer Society and Mark Bruls, K. H. and van Wijk, J. (1999) Squarified treemaps In Proceedings of the Joint Eurographics and IEEE TCVG Symposium on Visualization pages 33-42. Same is the case with zoom-in view. Since zoom mode typically has more elements, it ends up using ‘squarify’ layout more often. A few other example layouts, “Ordered and quantum treemaps: Making effective use of 2d space to display hierarchies” (Bederson, Benjamin B. and Shneiderman, Ben and Wattenberg, Martin), “Enhanced spatial stability with hilbert and moore treemaps” (S. Tak and A. Cockburn) and 3d Tanaka, Y., Okada, Y., and Niijima, K. (2004) Interactive interfaces of treecube for browsing 3d multimedia data In Proceedings of the Working Conference on Advanced Visual InterfacesAVI '04 pages 298-302 New York, N.Y., USA. ACM. Note this invention does not limit to this layout and can work with other layouts. One algorithm is given here to show feasibility of the system.

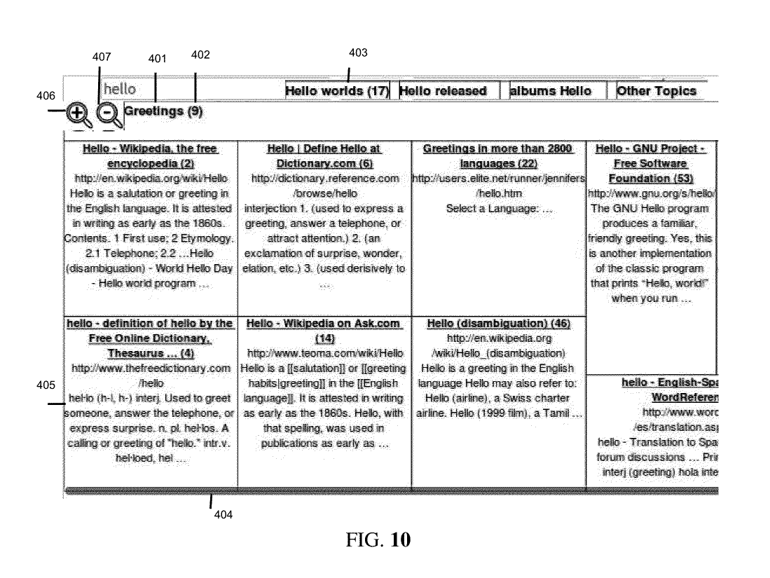

FIG. 10 is one zoom mode view of the multiple windows based interactive GUI. It can show cluster/topic/category/facet details and document details as discussed in normal mode. The system allows the option of going directly to other clusters/topics/categories/facets treemapzoom otherclusters 403. It is similar to normal mode with all other aspects including search box, filter box, scroll, treemapzoom scroll 404 interactive options like treemapzoom maximize 405 and treemapzoom minimize 406. The treemapzoom maximize 405 also does an additional search with the cluster/topic/category/facet title words and gets more results which are shown along with the documents of the cluster/topic/category/facet. The treemapzoom minimize 406 option takes the user back to the normal mode search summary.

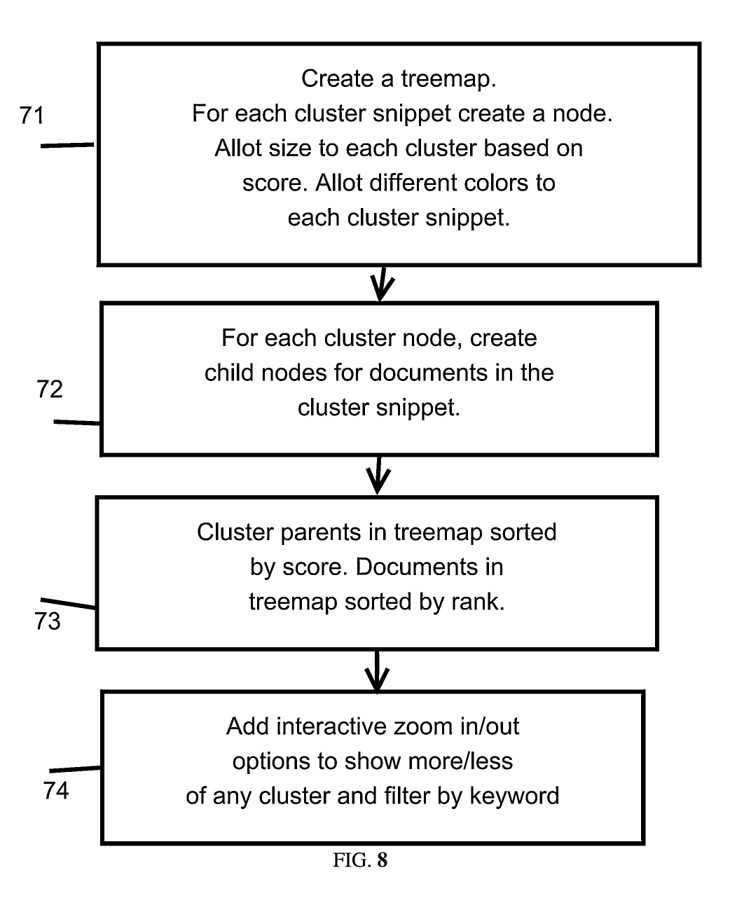

FIG. 8 is a view of the processes involved in creating the multiple windows based interactive GUI for search results. The first step involves allotting space to each cluster/topic/category/facet snippet. The number of document snippets in cluster/topic/category/facet summary could be a constant or a variable. In constant case, the cluster/topic/category/facet summaries are allotted same amount of screen space. For variable space the following is done. Based on cluster score, each cluster/topic/category/facet snippet is allocated a portion of the screen. Each cluster/topic/category/facet snippet is allocated a parent node in the treemap with documents it's children, treemap cluster 71 and treemap document 72. Based on screen space, a configurable area is fixed for each document snippet. Cluster/topic/category/facet snippet area is divided by each document snippet area to get number of document snippets to be shown for the cluster/topic/category/facet snippet. There is also a configurable minimum document snippets to be shown for each cluster/topic/category/facet snippet. This minimum document snippet is particularly useful to show clusters/topics/categories/facets that would otherwise be not shown at all because they have been allotted less space by the layout algorithm. Cluster/topic/category/facet parents are sorted by score, higher score clusters are shown first, treemap sort 73. Cluster/topic/category/facet document children are sorted by rank, higher rank documents are shown first. The options of horizontal scroll/swipe/mousewheel/arrow keys, etc are added. Colors are allotted to clusters/topics/categories/facets to make them easily distinguishable from one another. Options like fisheye are provided which increase the size and show all details when user hovers over the document or cluster/topic/category/facet. On zoom in/out selection, treemap interact 74, the treemap GUI is translated to the cluster/topic/category/facet start. The cluster/topic/category/facet document children node sizes, if configured to be increased based on screen size, they are increased. Treemap layout is used to calculate exact coordinates for each cluster/topic/category/facet and document. One way of creating layout is given here. The summary screen uses ‘slice-dice’ layout if number of clusters/topics/categories/facets is less than a configurable value, else uses ‘squarify’ layout, for references to both these algorithms, please see, Shneiderman, B., Wattenberg, and Martin (2001) Ordered treemap layouts In Proceedings of the IEEE Symposium on Information Visualization 2001 (INFOVIS '01)INFOVIS '01 pages 73—Washington, D.C., USA. IEEE Computer Society and Mark Bruls, K. H. and van Wijk, J. (1999) Squarified treemaps In Proceedings of the Joint Eurographics and IEEE TCVG Symposium on Visualization pages 33-42. Same is the case with zoom-in view. Since zoom mode typically has more elements, it ends up using ‘squarify’ layout more often. A few other example layouts, “Ordered and quantum treemaps: Making effective use of 2d space to display hierarchies” (Bederson, Benjamin B. and Shneiderman, Ben and Wattenberg, Martin), “Enhanced spatial stability with hilbert and moore treemaps” (S. Tak and A. Cockburn) and 3d Tanaka, Y., Okada, Y., and Niijima, K. (2004) Interactive interfaces of treecube for browsing 3d multimedia data In Proceedings of the Working Conference on Advanced Visual InterfacesAVI '04 pages 298-302 New York, N.Y., USA. ACM. Note this invention does not limit to this layout and can work with other layouts as treemaps. One algorithm is given here to show feasibility of the system.

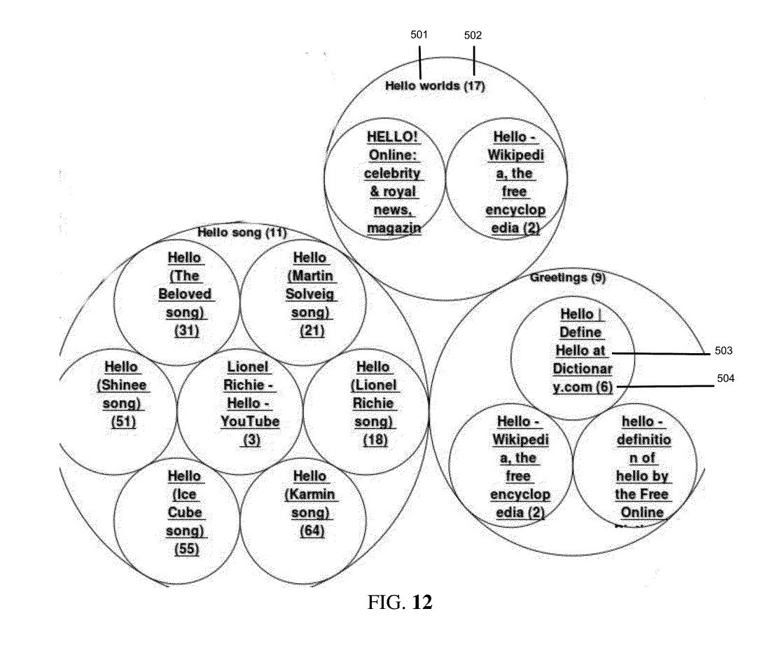

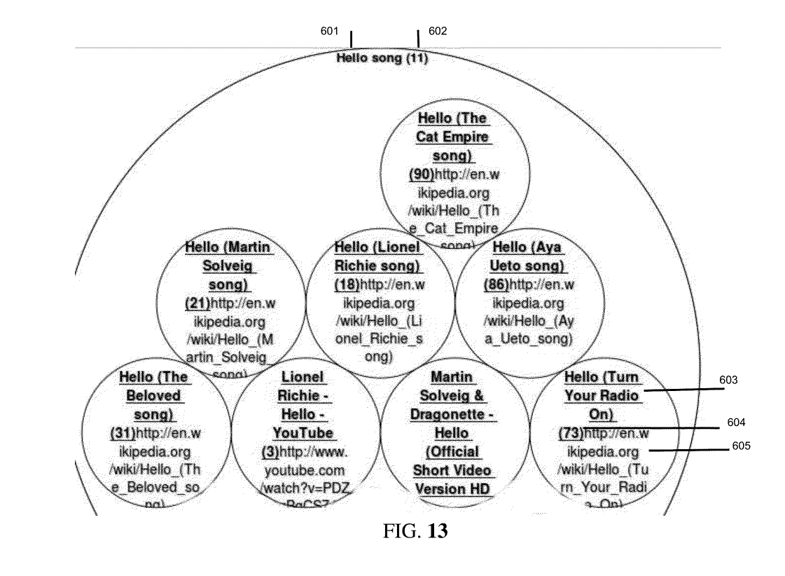

A third concrete/specific visualization for the interactive visualization system of this invention uses circles or balloons. FIG. 12 shows a perspective view of the circles/balloons GUI. The invention displays the clusters/topics/categories/facets as circles, circlegui cluster 501. Cluster/topic/category/facet title and number of documents in the cluster/topic/category/facet are shown, circlegui clusternumdocs 502. The documents are shown as sub-circles, circlegui doc 503. Documents are shown similar to other GUI realizations with document snippet which can consist of title, rank, url, document extract, etc. Scroll is also similar. The search summary is shown in terms of cluster/topic/category/facet snippets to give a peek into entire search results. Parents are sorted by score and documents sorted by rank. Use of cluster/document area and color is done as discussed earlier. The user can click/tap on any cluster/topic/category/facet to see more documents in it. FIG. 13 is one zoom mode view of the multiple windows based interactive GUI. This is also similar to other GUI realizations.

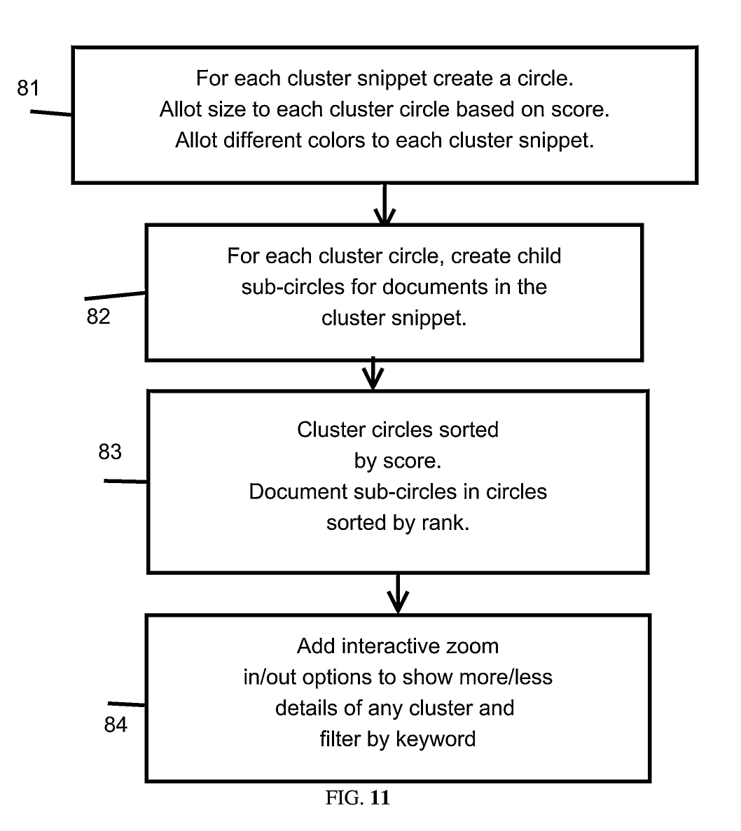

FIG. 11 is a view of the processes involved in creating the multiple circles based interactive GUI for search results. The first step involves allotting space to each cluster/topic/category/facet snippet. The number of document snippets in cluster/topic/category/facet summary could be a constant or a variable. In constant case, the cluster/topic/category/facet summaries are allotted same amount of screen space. For variable space the following is done. Based on cluster/topic/category/facet score, each cluster/topic/category/facet snippet is allocated a portion of the screen. Each cluster/topic/category/facet snippet is allocated a circle circle cluster 81. Based on screen space, a configurable area is fixed for each document snippet. Cluster/topic/category/facet snippet area is divided by each document snippet area to get number of document snippets to be shown for the cluster/topic/category/facet snippet. There is also a configurable minimum document snippets to be shown for each cluster/topic/category/facet snippet. This minimum document snippet is particularly useful to show clusters/topics/categories/facets that would otherwise be not shown at all because they have been allotted less space by the layout algorithm. The document snippets in the cluster/topic/category/facet snippet are made sub-circles in the cluster circle, circle document 82. Cluster/topic/category/facet parents are sorted by it's score, higher score ones are shown first. Cluster/topic/category/facet document children are sorted by rank, higher rank documents are shown first. The options of horizontal scroll/swipe/mousewheel/arrow keys, etc are added for scrolling. Colors are allotted to clusters/topics/categories/facets to make them easily distinguishable from one another. Options like fisheye are provided which increase the size and show all details when user hovers over the document or cluster/topic/category/facet. On zoom in/out selection, the treemap GUI is translated to the cluster/topic/category/facet start. The cluster/topic/category/facet document children sizes, if they can be increased based on screen size, they are increased. One layout algorithm for calculating positions of circles uses pack layout, “Solving the problem of packing equal and unequal circles in a circular container” (Grosso A, Jamali A R, Locatelli M and Schoen F). Note, this invention does not limit the layout algorithm used for circle packing and can work just as well with others. One algorithm is given here to show feasibility of the system.

Cluster titles are most important in giving an idea about the cluster. This invention improves the quality of clusters and cluster titles generated. In addition to frequency of keyword itemsets, this patent additionally uses ‘similar search’ keywords to choose the best words to show in the cluster title. The words in ‘similar search’ keywords are given highest priority in choosing cluster titles. Clusters with words from ‘similar search’ keywords are also given higher ranking/weight.

### Modifications

It will be appreciated that still further embodiments of the present invention will be apparent to those skilled in the art in view of the present disclosure. It is to be understood that the present invention is by no means limited to the particular constructions herein disclosed and/or shown in the drawings, but also comprises any modifications or equivalents within the scope of the invention.

What is claimed is:

1. A search result topics/clusters/categories/facets' visualization system, showing more than one search cluster/topic/category/facet document snippets at a time. No other search clusters/topics/categories/facets' display system shows document snippets from more than one cluster/topic/category/facet at a time.

2. A system which takes clusters/topics/categories/facets and generates summary/snippet for each cluster/topic/category/facet, the summary/snippet comprises a few document snippets in addition to one or more other things like title, rank and number of documents. The number of document snippets included in cluster/topic/category/facet summary/snippet could be constant or variable.

3. A clustering system which uses ‘similar search’ keywords to choose the best words for the cluster/facet title. The words in ‘similar search’ keywords are given highest priority in choosing cluster/facet title words. Clusters/topics/categories/facets with words from ‘similar search’ keywords are also given higher ranking/weight/score after ‘search keywords’.

4. In claim 1 and claim 2 number of document snippets to include in a cluster/topic/category/facet summary/snippet can also vary based on rank/score proportionate space for the cluster/topic/category/facet on the display screen. A configurable entry allows for any minimum document snippets to be allocated to cluster/topic/category/facet summary/snippet.

5. A visualization system for search results having a summary/big picture view of search results in terms of cluster/topic/category/facet snippets using claim 1, claim 2 and optionally using claim 4

6. In claim 5 the summary/big picture view of search results can additionally comprise of the following
Gap space between clusters/topics/categories/facets.
Higher ranked clusters/topics/categories/facets placed before lower ranked clusters/topics/categories/facets and higher ranked documents placed before lower ranked ones. item This invention does not limit the layout of clusters and couments and can work with other layouts. For example, could have horizontal layout with each cluster/topic/category/facet taking one entire horizontal row. Could have vertical layout with each cluster/topic/category/facet taking one entire vertical row. Could have treemap layouts slice/dice, squarify, slice, dice, etc.

7. In claim 5, one or more interactive options provided in terms of seeing more results of any topic on a click, less results of a topic/cluster/category/facet or filtering out a topic/cluster/category/facet altogether, seeing more topics/clusters/categories/facets, seeing a result document, etc

8. In claim 5 and claim 7, additionally allow multiple devices to browse results. Can use flip/swipe/mouse scroll/keyboard keys to see more clusters/topics/categories/facets. Can use tap/click on cluster/topic/category/facet to see more/less/filter results of topic. Can use tap/click on document to go to the document or back to results.

9. In claim 7, provides at least two detailed zoom views for each cluster/topic/category/facet. One level is seeing more results of the selected cluster/topic/category/facet in current search results. Another level makes an additional search with the selected cluster/topic/category/facet title automatically and gets further search results related to the selected cluster/topic/category/facet from the document sources. Levels also correspond to any hierarchy in clusters/topic/categories/facets, so any sub-clusters at say level 1 will show up more results in level 2.

10. Hierarchical clusters/topics/categories/facets are serialized in big picture view of claim 5 They are shown as proper cluster/topic/category/facet snippets with parent, children and interaction in zoom modes of claim 9, allowing further zoom levels. The GUI works recursively to show summary of sub-clusters and giving option of getting more details in case of sub-clusters.

11. In claim 5, ads can be shown as a separate cluster/topic/category/facet with configurable position in GUI. Ads can also be shown in specific positions within clusters/topics/categories/facets based on configuration entries of cluster/topic/category/facet number and positions.

12. In claim 5, a filter by keywords search option can be provided based on configuration.

13. Filter search in claim 12, adds a cluster/topic/category/facet with new search keywords as title and new search result documents as cluster documents and displays it. This new cluster/topic/category/facet is given highest score/rank, and is shown first right after the filter search.

14. In claim 5, the user can also save the results locally or on a remote server and also share it with others through social APIs.

15. Show search summary/big picture view of claim 5 and claim 6 using traditional windows/rectangles. Each cluster/topic/category/facet is given a window/rectangle. The documents are given sub-rectangles in parent cluster window/rectangle. Corresponding to claim 7, interactive options are provided. All options corresponding to claim 8 to claim 14 are provided.

16. Show search summary/big picture view of claim 5 and claim 6 using modified treemap, where the modified treemap can show partial nodes at a visible level unlike traditional treemap showing all children at any visible level. An additional modification introduces space gaps between sibling clusters/topics/categories/facets to make them better distinguishable. Corresponding to claim 7, interactive options are provided. All options corresponding to claim 8 to claim 14 are provided.

17. Show search summary/big picture view of claim 5 and claim 6 using circles/balloons. Each cluster/topic/category/facet is given a circle with documents as sub-circles. Corresponding to claim 7, interactive options are provided. All options corresponding to claim 8 to claim 14 are provided.
